(19) United States
(12) Patent Application Publication
(10) Pub. No.: US 2020/0224814 A1
(43) Pub. Date: Jul. 16, 2020

(54) Near vacuum composite material can be quickly wrapped up on surface of pipes by zipping it up and used for various sandwiched layers to reduce the noise and preserve heat

(71) Applicant: Da-Kuang Chang, San Francisco, CA (US)

(72) Inventor: Da-Kuang Chang, Taipei (TW)

(21) Appl. No.: 16/602,074

(22) Filed: Aug. 1, 2019

(30) Foreign Application Priority Data
Jan. 10, 2019 (TW) 108200424

(51) Int. Cl. F16L 59/02; F16L 59/14; F16L 59/065; A47G 19/22

(52) U.S. Cl. CPC F16L 59/028; F16L 59/14; F16L 59/065; B32B 1/08; F16L 59/021; A47G 19/2288; B32B 2250/40; F16L 59/029

(57) ABSTRACT

Currently wood frame dwellings in North American and the steel structures of the building constructions worldwide, in which the row of toilet water pipes are routed within the fire wall, when the toilet flushes, the water enters into the drainage pipeline. The original static air generates a huge sound wave, and the laminated mezzanine formed by the fireproof gypsum board outside the wood structure wall will increase the noise due to resonance, and the quality of life in the living space will be greatly disturbed. Therefore, some kind of sound insulation is required. Sound proof composite materials prevent noise, while the space walls and interior walls of high and low-latitude structures are heat-retaining and energy-saving. In addition, air-conditioning and hot water pipelines in buildings need to be insulated and cold-resistant to provide good insulation, using flame-retardant materials. In particular the plumbers need to do the installation of insulation construction fast and alone. In addition, due to the global ban on single-use plastic cups and paper cups with plastic coated inner layer the double-layered cold-insulated, heat-preserving aluminum foil cups, capable of keeping cold/warm and meeting environmental recycling requirements, are very much needed by the market.

### TECHNICAL FIELD

The present invention relates to a known cold insulation, sound insulation material and process technology. At present, cold water and heat insulation materials are required on ice water type or hot water type air conditioners and high pressure steam lines. At present, no zipper type quick and easy method is used for muffled pipelines, and no vacuum insulation layer is applied to obtain better sound insulation, cold insulation, flameproof and flame retardant effects in the pipelines and sandwiched layer of wall structures of the building.

### PREVIOUS TECHNOLOGY

At present, in the exterior of the toilet drainage pipe arranged inside the fireproof gypsum board clamp wall of the wood frame dwelling and the steel structure building, there are no prior configuration of soundproof silencing, and when the upper floor resident uses the flush toilet drainage, it will produce huge noise. The same configuration is also not found on the exterior of the cold insulation pipe. The vacuumed sandwich, flame retardant and flameproof zipper strips are used to cover the pipeline to achieve rapid on-site construction. The prior technology uses tape or magic quick stickers to achieve the purpose of rapid wrapping of pipelines, but one more process in production will increase the cost, and because each construction worker will use different adhesive tape to cover and packaging, resulting in a reduction in sound-damping and energy-saving effects. At the same time, there is no good insulation layer in the space between the interior and exterior walls of the building. The flameproof and vacuum insulation layer is applied to obtain the best sound insulation, cold insulation heat preservation, flame retardant and flameproof effects.

### UTILITY PATENT CONTENT

The present Utility invention first must use high-density sound-absorbing fireproof fiber wrapped outside the drainage pipe to absorb the amplitude of the sound wave, and then use the vacuum chamber to block the transmission generated by the sound wave resonance. In the past and present, plastic zipper function is only applied on food and stationary application. The zipper strips of the same corresponding group are deployed on the front and the back of the same fire-retardant and flame-proof film. At the end, the use of flame-retardant and flame-proof zipper strips are applied to achieve the purpose of the construction by a single technician to quickly wrap pipelines, while adding noise reduction and insulation functions on the same near vacuum material for a variety of pipelines to be muted and energy-saving. This would completely solve the difficulty for a single technician to quickly warp the pipelines, and can be applied in a variety of needs to save energy with the aforementioned combination of materials and process technology to achieve vacuum noise reduction and better insulation, etc.

The innovation of the present invention is that: In addition to the innovative composite materials, the innovative composite material can be quickly applied to the exterior of a drainage pipe by a single technician at the site, because a single coating material has a plurality of functions and can be applied to building materials in addition to sound insulation. The exterior of the silencer and chemical pipeline needs insulation, and the multi-purpose vacuum flame-proof and flame-retardant interlayer can achieve multiple benefits such as noise insulation and heat insulation. It can also shield the continuous fixture application in the exterior wall sandwich of the building to achieve energy saving of the air conditioning. It can also be applied to aircraft. Inside the mezzanine is the cabin insulation, which eliminates noise from jet engines and wind turbines. It can also be applied for high-temperature sun-protection and cold-weather sunscreens for automobile containers, and agricultural vegetables, and noise reduction in freeway silencing walls. The vacuum sandwich can also use appropriate cutting and stitching processes to ensure vacuum. The optional waterproof fabric or fire-retardant fiber and insulation lining can be used to make the best 1000° C. fire-resistant vacuum insulated fireproof clothing for firefighters. Optimal cold-insulated vacuum clothing can also make the best polar tent. The same near vacuum space can also be used for ice container, hot drinks, and pharmaceutical ingredients to achieve prolonged cold insulation.

### A SIMPLE DESCRIPTION OF THE SCHEMA

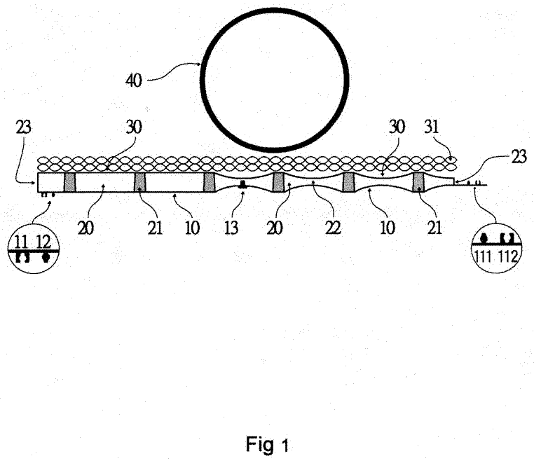

FIG. 1 is a schematic drawing of the main components of the invention.

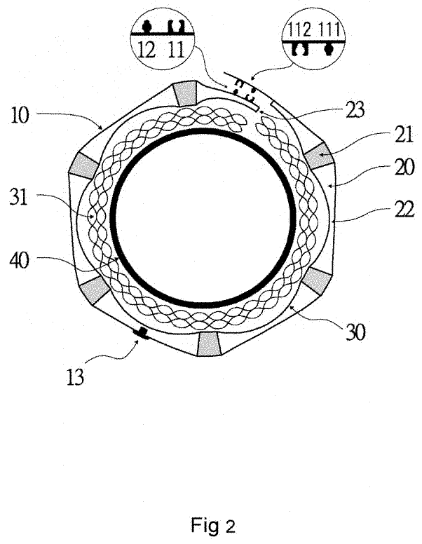

FIG. 2 is a schematic drawing of this invention applied to the coating pipeline.

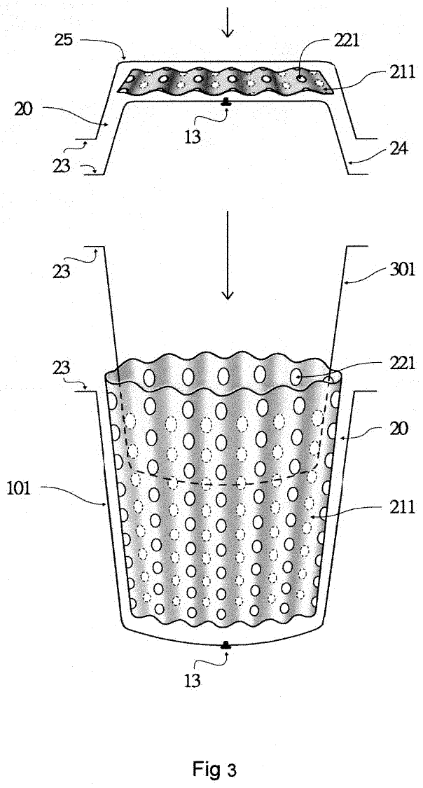

FIG. 3 is a schematic drawing of this creative application applied to a multi-layer food and cold/warm beverage container and lid.

### APPLICATION METHOD

The present invention utilizes a plan perspective view FIG. 1 to illustrate the following embodiments: (10) is a metal film of width (outer diameter of pipeline x3.1416) X1 (if two layers are required, x2, when three layers are required, x3) plus 2 inches (setting the width of the sealed zipper), and length of the general-purpose pipeline (for example, 8 feet). A metal gauze (21) is pasted on (10) to open a space (20), because the film (10) and (30) are originally flat before the vacuum is applied, but under the vacuuming operation of the (13) suction valve, two films (10) and (30) will be closely adhered. To prevent the (10) and (30) films from touching each other, the metal gauze (21) is placed between (10) and (30) films. The thickness and hardness are matched with the height of (21) to ensure that after the vacuum is completed, the original (20) position between (10) and (30) is changed to (22), so it is necessary to use the metal gauze (21). The height of the gauze is such that there is no contact at the (22) grid location, blocking the heat and sound wave transfer.

On the left side of the center point (13) of the film (10) of FIG. 1, the two films (10) and (30) are not in contact with each other before the vacuum is applied. On the right side of the center point (13), after vacuuming, the two films (10) and (30) are kept open by the metal gauze (21) at the (22) grid position to maintain a near vacuum, non-contact state. A concave groove (11) zipper and a convex groove (12) zipper are provided at the bottom left of (10), and a convex groove (111) zipper and a concave groove (112) zipper are provided at the upper right portion of (10). (30) is a metal film with the same length and width as (10), but with a width of 2 inches less than (10) on the right side. A high density, ⅕ inches thick sound-absorbing and flame-retardant heat-insulating fiber layer (31) is placed on (10), and is crimped and bonded at periphery (23) by a high-frequency heat fusion machine to form a rectangular space layer (20). Vacuuming via a (13) suction valve turn (20) space into a plurality of (22) near vacuum chambers.

In FIG. 2, the combination of (10), (11), (12), (111), (112), (13), (21), (30) and (31) is a schematic diagram of composite material with near-vacuum sound insulation and noise reduction applied to the wrapped pipeline. The top of the self-draining drainage pipe (40) is fixedly wrapped with double-sided tape on the outside of the vertical drainage pipe (40). A single thumb is applied from top to bottom: the male convex groove (111) is pressed into the concave groove of the (11), and the concave groove (112) is again pressed into the (12) convex groove, and finally, a 2 inch wide flame-retardant tape is applied from top to bottom to the right of (10). At the same time, a 2 inch wide fire-retardant tape should also be used to wrap around the top and bottom of the drainage pipe.

If the effect of sound insulation is not as expected, the composite near vacuum sound-absorbing and insulating material can be used to cover the drainage water pipe twice or more to obtain the best results; but when the pipeline is to be coved multiple times, the original (11) concave and the (12) convex position should be changed in coordination.

A near vacuum sound-absorbing and heat-insulating composite material is further described in detail in FIG. 3 by using an iced beverage container and a lid. An aluminum foil cup made of a cup inner film (301) is used to sheath a cup outer film (101). To make large-size aluminum foil cups, use a recycled pulp between the inner aluminum foil cup (301) and the outer aluminum foil cup (101). Insert a circular wave-shaped multi-hole low-conductivity lining bracket (211) between the inner aluminum foil cup (301) and the outer aluminum foil cup (101). The cup top edge (23) is sealed. A suction valve (13) is heat-sealed at the bottom of the cup (101) to ensure that there is no contact between the inner and outer cups after vacuuming. At (221) there is a near vacuum space. The lids bottom inner film (24) and the top cover outer film (25) shall be placed in the same support frame (211) closed at the cover edge (23). A suction valve (13) is heat-sealed at the bottom of the lid (24). A multi-layer insulated container with lid for food and cold/warm beverage is completed.

The function of the composite material in cold/warm beverage cup application must have a low conductive lining bracket (211), because the inner cup (301) and outer cup (101) materials are too thin to support the near-vacuum space (221) to make the inner cup (301) and the outer cup (101) not contacting each other at the (20) position to achieve the purpose of keeping cold or keeping warm. For a cup-shaped beverage container, when the atmospheric pressure is applied to the outside of the inner cup (301), the outer dimensions of the inner cup (301) will not be changed due to the surface tension of the columnar material. When people choose thicker or higher strength material for the outer cup (101), the outer cup (101) shape does not change after vacuum, the inner aluminum foil cup (301) would not make contact with outer aluminum foil cup (101), ensure that (20) position would have near vacuum space, then there is no need to have support frame (211) and still achieve the purpose of insulation of keeping cold or keeping warm.

### SYMBOL DESCRIPTION

10 Composite outer layer

11 Concave plastic zipper strip

12 Convex plastic zipper strip

13 Suction valve

20 Near vacuum chamber

21 Low conductivity material to be placed in order to make (20) space

22 The room (20) must have a non-contacting near-vacuum space at this location

23 Hot-pressing and welding position

24 Cover bottom

25 Cover upper

30 Composite Coating

31 High density fire and flameproof insulation fiber layer

40 Pipe-line

101 Outer foil cup

111 Convex plastic zipper strip

112 Concave plastic zipper strip

211 Round wave with multi-hole low conduction lining bracket

221 Non-contacting near-vacuum space

301 Inner foil cup

1. A near vacuum composite material can be quickly wrapped up on the surface of pipes by zipping it up and used for various sandwiched layers to reduce the noise and preserve heat in a variety of applications, as shown in FIG. 1. Its characteristics include: (A) Composite film outer layer (10) and the thin film layer (30) is applied to the pipeline, and the length and width of the thin film layer (30) are formed according to the actual required size. (B) Ultrasonic pressure fusion is used to form the shape to be applied in the surrounding (23) position. (C) A vacuum valve (13) is heat-sealed on the outer film (10). The space (20) can be used for sound insulation and keeping temperature from rising. (D) Built-in low-conductivity material (21), are used as spreader at multiple (22) positions between (10) and (30) film layers. Position (22) shall have near-vacuum non-contact space, achieving the purpose of preventing the sound wave resonance and the heat and cold from transmitting and heat-insulating. High-density sound-absorbing flame-retardant combustion-resistant fiber (31) is attached to the thin film layer (30). (A),(B),(C),(D) are combined together into a composite material, which can be quickly applied on the outside of the pipeline (40) by a single technician, including covering outside of the uniquely curved pipelines, continuous shielding applications inside and outside the building, and all kinds of industrial products that require near-vacuum sound insulation and flame retardance.

2. A composite material as described in claim 1, including FIG. 2, using the (111) convex zipper strips and (112) concave zipper strips attached on the right side of (10). The composite material is wrapped around the pipeline (40) in the same direction as the central axis, and then combined with the (11) concave zipper strip and the (12) convex zipper strip attached to the lower left of the (10). A single technician can quickly do the job at the construction site. The material is quickly wrapped and fixed on the outside of the pipeline (40), using a single or multiple set of zipper strips, changing the positions of the (11) concave zipper strips and the (12) convex zipper strips as needed. More than one layer can be applied on the outside of the pipeline (40) to achieve optimal acoustic wave resonance and thermal insulation.

3. As shown in FIG. 3, an environmentally-friendly recycled pulp with multi-hole wave-shaped low-conductivity round cup support liner (211) is placed between aluminum foil made inner cup (301) and outer cup (101). Heat sealed a vacuum valve (13) at the bottom of (101) the aluminum foil cup and heat-press the top (23) of the cup and vacuum through (13) to complete the construction. The outer film aluminum foil cup (101) and the inner film aluminum foil cup (301), with all holes (221) in the support frame (211), would be of no contact with each other with near vacuum space. The lid must also be inserted with the lining bracket (211) using the same process as previously described. Heat sealed vacuum valve (13) in the lid rim (23) to heat seal the beverage in the (301) aluminum foil cup. A composite material used in the multi-layered food and cold/warm beverage cup and lid assembly is completed, including the exemption of the (211) support frame. The use of thicker and stronger materials for the production of the outer cup (101), ensuring that after completion of vacuuming through the (101) outer cup bottom vacuum pumping valve (13) so that there is a non-contact vacuum space (20) between the inner aluminum foil cup (301) and the outer cup (101), and a composite material cup with no supporting bracket for the food and cold/warm beverage is completed.
